(19) United States
(12) Patent Application Publication
(10) Pub. No.: US 2025/0309966 A1
(43) Pub. Date: Oct. 2, 2025

(54) COMMUNICATION DEVICES AND METHODS

(71) Applicant: Sony Group Corporation, Tokyo (JP)

(72) Inventors: Ken TANAKA, Stuttgart (DE); Kosuke AIO, Stuttgart (DE); Thomas HANDTE, Stuttgart (DE); Daniel VERENZUELA, Stuttgart (DE)

(73) Assignee: Sony Group Corporation, Tokyo (JP)

(21) Appl. No.: 18/864,912

(22) PCT Filed: Apr. 19, 2023
(86) PCT No.: PCT/EP2023/060153

§ 371 Date: Nov. 12, 2024

(30) Foreign Application Priority Data
May 19, 2022 (EP) 22174237.2

(51) Int. Cl. H04B 7/06

(52) U.S. Cl. CPC H04B 7/0696; H04B 7/0617; H04B 7/0626

(57) ABSTRACT

A first communication device operating as source node sends a collaborative transmission (CT) link metric query to relay nodes which solicits the relay nodes to feedback measured/estimated values of several collaborative transmission data rate. At least one second communication device operating as relay node thus sends a CT link metric response to the source node. The CT link metric response includes measured/estimated values of several collaborative transmission data rate among relay nodes and sink nodes (non-AP STAs).

### BACKGROUND

### Field of the Disclosure

The present disclosure relates to communication devices and methods, in particular to multi-access point (multi-AP) devices and methods for use in a multi-AP network.

### Description of Related Art

A multi-AP device is generally understood as a wireless Access Point (AP) that can transmit and/or receive signals in cooperation with (an) other AP(s). This cooperation includes joint processing, which means that several multi-AP devices transmit or receive signals at the same time to yield better performance leveraging spatial diversity. Multi-AP has particularly been considered for coverage extension and/or increasing robustness of wireless networks.

A wireless network making use of multi-AP may comprise a source node (also called “first multi-AP device” herein), one or more relay nodes (also called “second multi-AP device” herein) and one or more sink nodes (also called “third communication devices” or “non-AP STA” (station)). The source node is a communication device which is the source of sent data, the relay node is a communication device which relays the data to (an) other communication device, and the sink node is a communication device which is the destination of the data.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to improve the data throughput in a wireless network using collaborative transmission. It is a further object to provide corresponding communication devices and methods as well as a corresponding computer program and a non-transitory computer-readable recording medium for implementing the methods.

According to an aspect there is provided a first communication device configured to operate as source node and communicate with one or more second communication devices that are configured to operate as relay nodes and communicate with one or more third communication devices, the first communication device comprising circuitry configured to:
transmit a collaborative transmission (CT) link metric query to multiple second communication devices requesting them to collect CT link metric information with respect to collaborative transmission from two or more of said second communication devices to one or more third communication devices, the CT link metric query including one or more CT indications, each CT indication indicating a different combination of two or more second communication devices and/or different beamforming (BF) types for which CT link metric information shall be collected,
receive a CT link metric response from at least one of said multiple second communication devices in response to the transmitted CT link metric query, the CT link metric response including the collected CT link metric information,
decide, based on the CT link metric response, BF types to be used by the multiple second communication devices for collaborative transmission to one or more third communication devices, and
transmit BF type information indicating the decided BF types to the multiple second communication devices.

According to a further aspect there is provided a second communication device configured to operate as relay node and communicate with a first communication device configured to operate as source node, one or more other second communication devices configured to operate as relay nodes and/or one or more third communication devices configured to communicate with one or more second communication devices, the second communication device comprising circuitry configured to:
receive a collaborative transmission (CT) link metric query from the first communication device requesting it to collect CT link metric information with respect to collaborative transmission from the second communication device and one or more other second communication devices to one or more third communication devices, the CT link metric query including one or more CT indications, each CT indication indicating a different combination of two or more second communication devices and/or different beamforming (BF) types for which CT link metric information shall be collected,
transmit a CT link metric response to the first communication device in response to the transmitted CT link metric query, the CT link metric response including the collected CT link metric information, receive, from the first communication device, BF type information indicated decided BF types to be used by the second communication device for collaborative transmission to a third communication device, and
transmit data to a third communication device jointly with one or more other second communication devices using the BF type indicated for the second communication device in the received BF type information.

According to still further aspects corresponding methods, a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of the disclosure is to foresee a way of link metric indication from relay nodes to the source node so that optimized collaborative transmission (sometimes also called joint transmission) can be performed by the relay devices depending on data traffic and/or intended sink node(s).

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a schematic diagram of a multi-AP network in which the communication devices according to the present disclosure may be used.

FIG. 2 shows schematic diagrams illustrating different types of collaborative transmission, non-joint transmission and dynamic point selection.

FIG. 3 shows a flow chart of an embodiment of a first communication method according to the present disclosure.

FIG. 4 shows a flow chart of an embodiment of a second communication method according to the present disclosure.

FIG. 5 shows a diagram illustrating a more detailed embodiment of a communication scheme of the communication between the different communication devices according to the present disclosure.

FIG. 6 shows a diagram illustrating an embodiment of a CT link metric query frame according to the present disclosure.

FIG. 7 shows a diagram illustrating another embodiment of a communication scheme of the communication between the different communication devices according to the present disclosure.

FIG. 8 shows diagrams illustrating an embodiment of a CT link metric response frame according to the present disclosure.

### DETAILED DESCRIPTION OF THE EMBODIMENTS

Before reference will be made to the drawings, some terms shall be explained. The term “multi-AP device” refers to a wireless Access Point (AP) that can transmit and/or receive signal in cooperation with (an) other AP(s). This cooperation includes joint processing, which means several multi-AP devices transmit or receive signal at the same time to yield better performance leveraging spatial diversity. The term “multi-AP entity” refers to the logical entity, which execute AP control functions, provide multi-AP specific control information, and may control the operation of the multi-AP network. The terms “fronthaul AP” and “backhaul STA” refer to the entities that are generally included in a multi-AP device and communicate with each other when communicating between multi-AP devices. Within a multi-AP network, a “fronthaul AP” is either connected to a “backhaul STA” or to a non-AP STA.

The term “source node” refers to a communication device (also called “first communication device” herein), which is the source of sent data. The term “relay node” refers to a communication device (also called “second communication device” herein) which relays the data to (an) other communication device (another relay node or a sink node (also called “third communication device” herein)). Each of source nodes and relay nodes have at least one fronthaul AP. Typically, source nodes have fronthaul APs and Ethernet ports, and relay nodes have backhaul STAs and fronthaul APs.

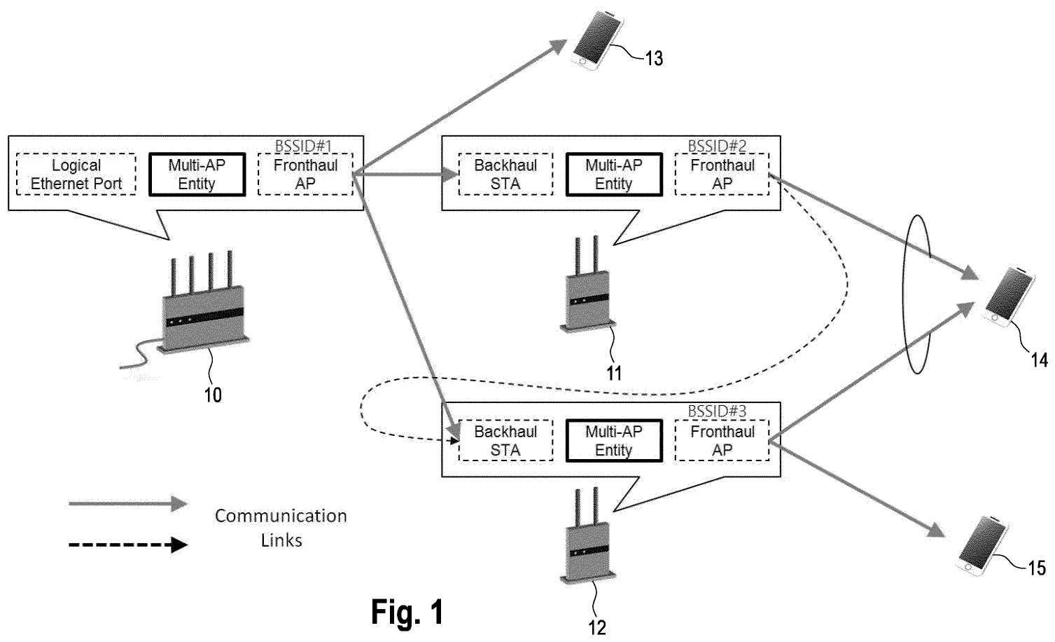

Referring now to the drawings, wherein like reference numerals designate identical or corresponding parts throughout the several views, FIG. 1 shows a schematic diagram of a multi-AP network in which the communication devices according to the present disclosure may be used. In this exemplary network multi-AP device 10 operates as source node and multi-AP devices 11 and 12 operate as relay nodes.

Multi-AP Device 10 has a multi-AP Entity and a fronthaul AP and can send signals made by fronthaul AP to non-AP STA 13 (operating as sink node; also called “third communication device herein), multi-AP device 11 and multi-AP device 12. If multi-AP device 10 is connected by Ethernet, it may have an Ethernet port instead of a backhaul STA. In the FIG. 1, an Ethernet port entity is shown as “Logical Ethernet Port”. Each of the multi-AP devices 11 and 12 has a backhaul STA, a multi-AP entity, and a fronthaul AP. As shown in FIG. 1, each of them executes signal processing of received signals from multi-AP device 1. Multi-AP devices 11 and 12 can communicate with each other. For example, if multi-AP device 11 sends control information to multi-AP device 12, the signal is sent from fronthaul AP of multi-AP device 11 to backhaul STA of multi-AP device 12, as shown by the dotted line in FIG. 1. Each fronthaul AP configures its own BSS (Basic Service Set) to differentiate its link. For example, the fronthaul AP of multi-AP device 10 has a first BSS that includes the fronthaul AP of multi-AP device 10, the non-AP STA 13, the backhaul STA of multi-AP device 11, and the backhaul STA of multi-AP device 12. Similarly, the fronthaul APs of multi-AP devices 11 and 12 have different BSSs and communicate with other non-AP STAs 14 and 15.

Multi-AP has been considered for coverage extension and/or robust network. In fact, Easy Mesh™ is standardized to provide functions for multi-AP network as well as IEEE 802.11s. A multi-AP network uses collection link metrics so that multi-AP devices can decide which route to choose to relay data to non-AP STAs. “Link Metric” is referred to as link quality between communication devices independent of wireless or tethered link. In Easy Mesh™, several formats are standardized to notify link metrics depending on a multi-AP device profile version, but fundamentally estimated data rate and/or measured data rate are chosen as link metrics. Similar statements can be made for IEEE 802.11s, in which air time of a link is used as follows:

$${c}_{a} = [ O + \frac{{B}_{t}}{r} ] \frac{1}{1 - {e}_{f}} \qquad ( 1 )$$

where O is channel access overhead, Bₜ is the number of bits in a test frame, r is the data rate and e_{f} is the frame error rate.

Especially in downlink communication, collaborative transmission (CT), which is usually called joint processing in 3GPP (Third Generation Partnership Project), can be mainly divided in three groups: 1) Joint Transmission (JT), 2) Dynamic Point Selection (DPS), and 3) Combination of JT and DPS. DPS refers to selecting an access point to be associated depending on channel condition etc., while JT refers to send signals from different APs to non-AP STA(s). In general, JT requires strict synchronization in frequency and time domain among APs. It is a hard requirement for WLAN communication devices to meet, but residual carrier frequency offset (CFO) errors between two WLAN devices can be suppressed within only 30 Hz, where it is a sufficient synchronization level for JT.

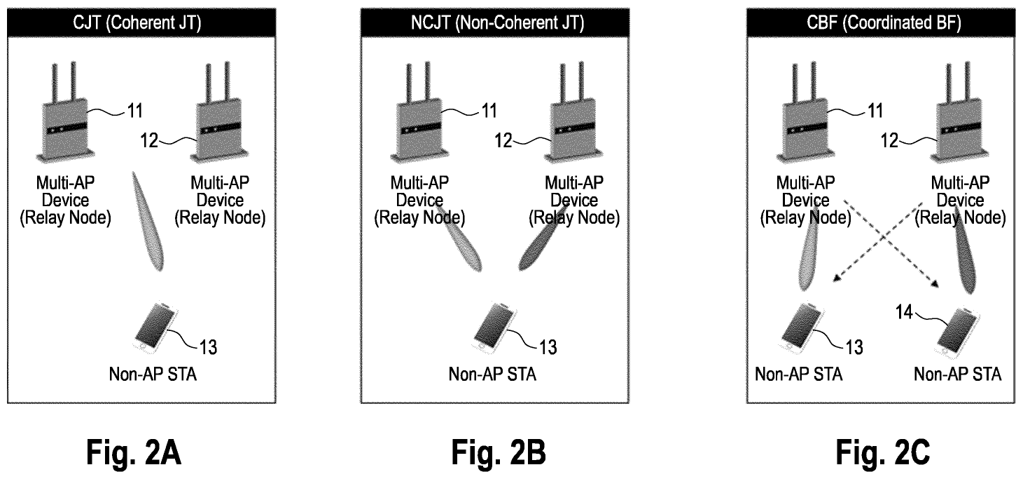

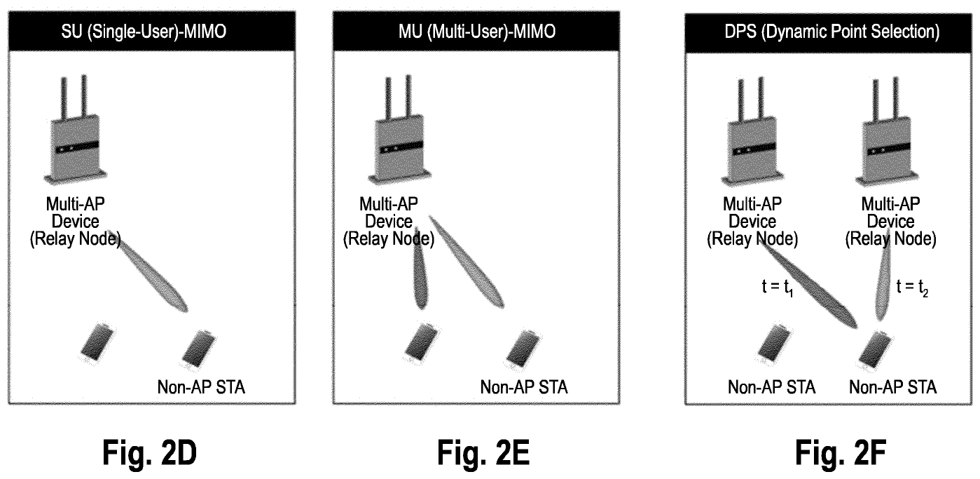

Especially JT can be further divided into several types, as illustrated in FIG. 2 showing schematic diagrams illustrating different types of joint transmission. These types are 1) Coherent Joint Transmission (CJT; FIG. 2A), 2) Non-Coherent Joint Transmission (NCJT; FIG. 2B), and 3) Coordinated Beam Forming (CBF; FIG. 2C). In CJT, several multi-AP devices perform as if they were one big multi-AP device, and consequently yield most spatial streams and beam gains in JT. However, each AP of the multi-AP device is required to have the same transmit data to be distributed via a backhaul CJT. In NCJT, each multi-AP device does not need to share data to be sent, but performance might be worse than in CJT. In CBF, each multi-AP device sends data to different non-AP STAs while they are likely to make null to unintended receivers. Since each multi-AP device makes null at the cost of spatial degree of freedom, performance might be even worse than CJT. If overhead such as data sharing is taken into account, the above performance relationship might be different, but performance might be different depending on the JT type.

FIGS. 2D and 2E show diagrams of Non-Joint Transmission, in particular for Single-User (SU) MIMO and Multi-User (MU) MIMO. FIG. 2F shows a diagram of Dynamic Point Selection (DPS).

As mentioned, CJT requires transmitters to share data to be sent. Referring to FIG. 1, multi-AP device 10 can send the data to multi-AP devices 11 and 12 in multicast way, because, if multi-AP device 10 sends the data in different spatial/frequency/time resources to the multi-AP devices 11 and 12, it would waste resources.

In multi-AP network as shown in FIG. 1, multi-AP devices 11 and 12 can perform JT, and multi-AP device 10 does not know channel qualities between other multi-AP devices and non-AP STAs. To make the best end-to-end data rate performance (from source node to sink node via relay node), multi-AP device 10 should know what types of JT multi-AP device 11 and 12 would perform because the data transmitted to multi-AP devices 11 and 12 would be different depending on the JT types. Furthermore, multi-AP device 11 and 12 can perform different JT depending on non-AP STAs such as CJT to non-AP STA 14 but not any JT to non-AP STA 15.

According to the scenario described above, only one estimated data rate among multi-AP devices 11 and 12 and non-AP STAs 14 and 15 can be informed to multi-AP device 10. Thus, multi-AP device 10 does not know which is the best JT way for multi-AP devices 11 and 12. Furthermore, the best JT type is different depending on the data traffic to non-AP STAs, which the multi-AP device 10 has.

According to the present disclosure, the way of link metric indication from multi-AP devices 11 and 12 to multi-AP device 10 is illustrated so that multi-AP devices 11 and 12 can perform the best CT depending on data traffic and/or intended non-AP STAs.

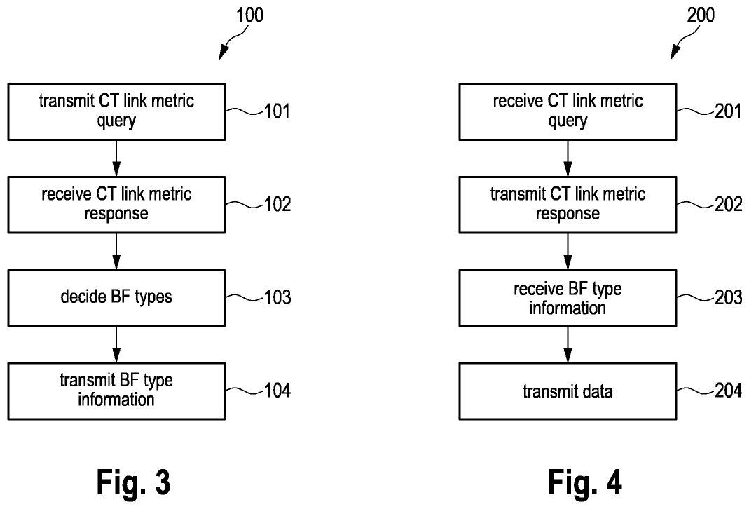

FIG. 3 shows a flow chart of an embodiment of a first communication method 100 that is performed by a first communication device (e.g. the multi-AP device 10) according to the present disclosure. In a first step 101 a CT link metric query (also simply referred to as link metric query) is transmitted by the first communication device to multiple second communication devices requesting them to collect CT link metric information (also simply referred to as link metric information) with respect to collaborative transmission from two or more of said second communication devices to one or more third communication devices (e.g. the non-AP STAs 14 or 15). The CT link metric query includes one or more CT indications, each CT indication indicating a different combination of two or more second communication devices and/or BF types for which CT link metric information shall be collected.

In a second step 102 a CT link metric response (also simply referred to as link metric response) is received from at least one of said multiple second communication devices in response to the transmitted CT link metric query. The CT link metric response includes the collected CT link metric information. In a third step 103 the first communication device decides, based on the CT link metric response, BF types to be used by the multiple second communication devices for collaborative transmission to one or more third communication device. In a fourth step 104 BF type information indicating the decided BF types is transmitted to the multiple second communication devices. In this context, BF types includes Coherent Joint Transmission, Non-Coherent Joint Transmission, Joint Transmission, Coordinated Beamforming and Non-Joint Transmission. The BF types can be decided for arbitrary RUs independently.

Beamforming (BF) shall generally be understood as a technique for directional signal transmission or reception such as MRC (Maximal Ratio Combination), etc. Collaborative transmission such as CJT, NCJT and CBF can also be seen as a part of BF because essentially transmitters form beams jointly or non-jointly to leverage spatial degree of freedom. Herein, BF type shall be understood as the type of beamforming as well as collaborative transmission. In other word, herein “CT type” shall be understood as “BF type” where multiple transmitters are assumed, but “CT type” does not include a BF type for only one transmitter.

Since the definitions of the term “Joint Transmission” are different depending on the standardization group such as 3GPP and IEEE 802.11, the term “Collaborative transmission type” (or “CT type”) shall herein be understood as referring to the type of collaborative transmission such as CJT, NCJT and CBF, but shall not be understood as a type of beamforming without collaborative transmission.

FIG. 4 shows a flow chart of an embodiment of a second communication method 200 that is performed by a second communication device (e.g. the multi-AP device 11 or 12) according to the present disclosure. In a first step 201 a CT link metric query is received from the first communication device requesting it to collect CT link metric information with respect to collaborative transmission from the second communication device and one or more other second communication devices to a third communication device.

In a second step 202 a link metric response is transmitted to the first communication device in response to the transmitted CT link metric query. In a third step 203, from the first communication device, BF type information indicated decided BF types to be used by the second communication device for collaborative transmission to one or more third communication devices is received. In a fourth step 204 data are transmitted to a third communication device jointly with another second communication device using the BF type indicated for the second communication device in the received BF type information.

The “BF type(s)” refer to 1) the variants of Joint Transmission as shown in FIGS. 2A, 2B, 2C (herein also referred to as CT types) and 2) beamforming without Joint Processing (i.e. non-joint transmission) as shown in FIGS. 2D and 2E. Essentially, Joint Transmission also can be seen as beamforming of multiple transmitters.

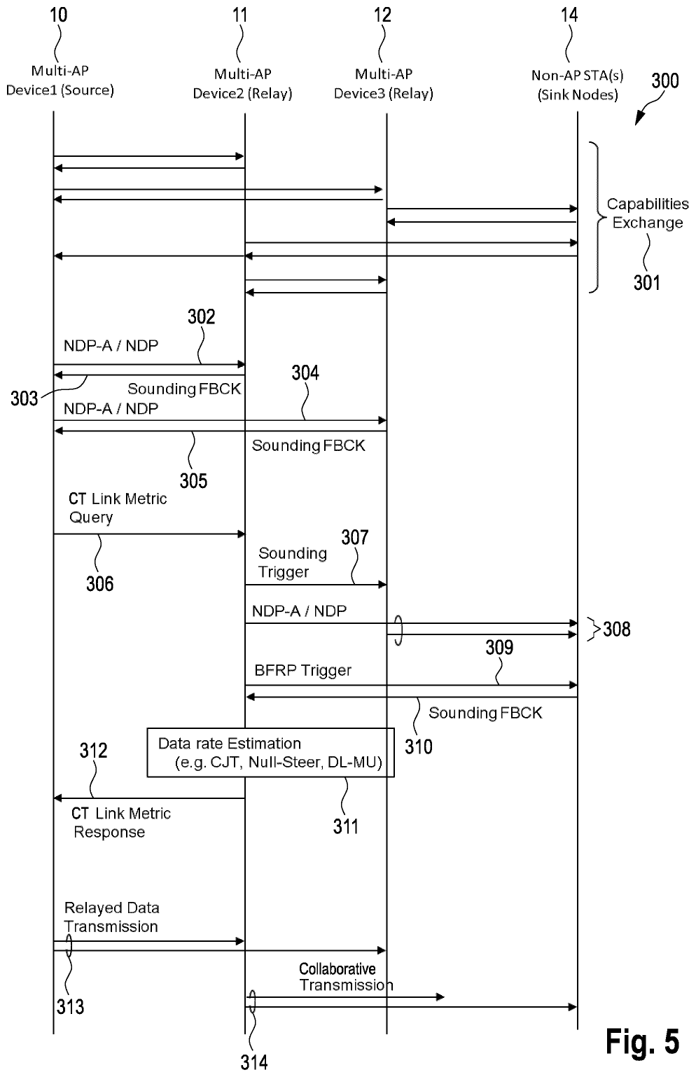

FIG. 5 shows a diagram illustrating a more detailed embodiment of a communication scheme 300 of the communication between the different communication devices according to the present disclosure. In this communication scheme there are one multi-AP device 10 (which is also a source node), several multi-AP devices 11, 12 (which are also relay nodes) connected with the multi-AP device 10, and non-AP STA(s) 14 associated with the multi-AP devices. For simplicity, an acknowledgement for each step is not illustrated in FIG. 5, but an acknowledgement may be carried out after each step. Further, in FIG. 5 two relay nodes are depicted as an example. In general, one or more relay nodes may be provided.

In a first step 301, the source node, the relay nodes and the non-AP STA(s) exchange their capabilities, including association. The “capabilities” refer to the kind of functions each communication device has, e.g. whether a multi-AP device can operate as source node and/or relay node, which collaborative transmission can be performed at each multi-AP device, by which BF types each non-AP STA can receive transmitted signals, etc. In an embodiment, the capabilities exchange between relay nodes and non-AP STA(s) follows the capabilities exchange between the source node and the relay nodes, but the sequence can be different. Furthermore, it is not illustrated in FIG. 5 that each non-AP STA's capabilities are relayed via relay nodes, but the capabilities can be directly sent to the source node from the non-AP STA. In this step, routing can also be determined.

After the capabilities exchanges are done, in a second and third step 302, 304 the source node sends NDP-A (null data packet announcement) and NDP to the relay nodes so that the source node can know the channel state between the source node and the relay nodes. The way of NDP-A and frame can be identical to the protocol and the control frames standardized in IEEE 802.11. In general, NDP-A configures the subsequent NDP, which may hold channel estimation sequences for the receiver to perform channel estimation. In FIG. 5, as step 308 another transmission of NDP-A/NDP from the multi-AP devices 11 and 12 to the non-AP STA 14 is provided. The framework of NDP-A and NDP transmission will be explained in more detail below.

After receiving NDP, the relay nodes send channel state information (“sounding feedback FBCK”) between the source node and the relay nodes to the source node (steps 303 and 305). In FIG. 5, another sounding FBCK is provided in step 307, where the non-AP STA(s) send channel state information between relay nodes to non-AP STA(s). The way of sounding FBCK and the frame can be identical to the protocol and the frames standardized in IEEE 802.11. The channel state information may particularly include data rate information on an estimated data rate regarding the channel between a relay node and a non-AP STA.

After capabilities exchanges are done, the source node solicits the relay nodes to feedback link metrics among the relay nodes and the non-AP STA(s) to the source node by transmitting a CT link metric query in step 306. After receiving the link metric query, the relay nodes shall send a CT link metric response to the source node within a certain duration (step 312). This duration can be informed in the CT link metric query and/or can be decided in the capabilities exchanges.

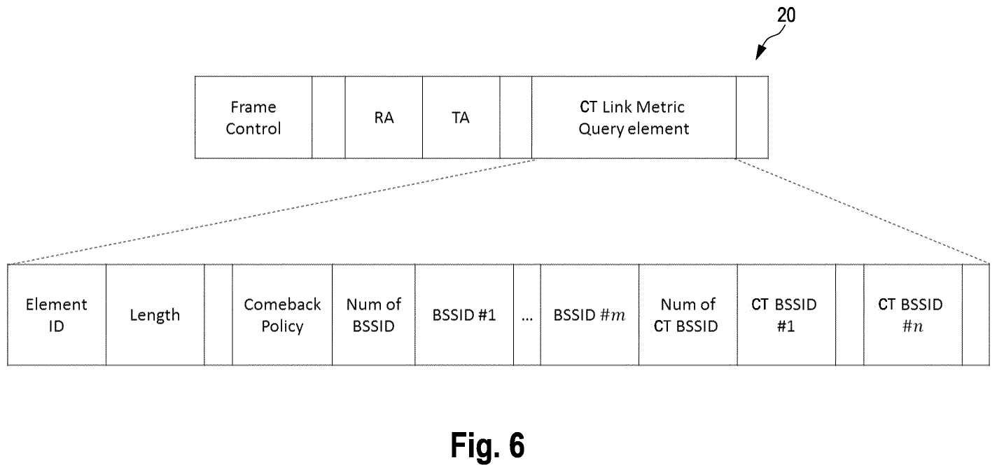

FIG. 6 shows a diagram illustrating an embodiment of a CT link metric query frame 20 according to the present disclosure. This frame may include one or more of the following fields (in an embodiment, all these fields are included; in other embodiments only single fields or groups of fields are included; additional fields may be included as well):
Frame Control: indicates types of this frame; basically, this field is interpreted with Element ID in the multi-AP Link Metric Query element;
RA (Receiving STA Address): indicates to which non-AP STA(s) this frame is intended to be sent (in FIG. 3 this field indicates both relay nodes 11 and 12);
TA (Transmitting STA Address): indicates from which non-AP STA this frame is transmitted;
CT Link Metric Query element: indicates the BSSs from which link metrics shall be responded.

The CT Link Metric Query element may include one or more of the following fields:
Element ID: indicates which element this element is;
Length: indicates which bits or octets are used in the CT Link Metric Query element;
Comeback Policy: indicates in what time each intended receiver as indicated by RA should respond to this frame at the latest (the values can be set different depending on Joint Transmission type for which the relay nodes estimate the data rate; this field can be omitted if this value is already known between the transmitters and receivers, e.g. if it is a standardized value);
Num of BSSID: indicates the number of the following consecutive BSSID fields;
BSSID #k: indicates k-th BSSID to respond with link metrics;
Num of CT BSSID: indicates the number of the following consecutive CT BSSID fields;
CT BSSID #k: indicates which combination of BSSIDs to respond with their link metrics of Collaborative Transmission (each BSSID may be understood as an identifier of a multi-AP device, and each “CT BSSID” may be understood as an identifier of a combination of multi-AP devices).

If Num of BSSID indicates 4 BSSIDs, CT BSSID field can be expressed by 4 bits (e.g. like a bitmap, where the k-th bit indicates that the BSSID indicated in BSSID #k field is included in the combination of BSSID that shall respond). This is because each of all possible combinations of CT among multi-AP devices indicated in Num of BSSID field can be expressed. For example, if CT BSSID #m field is expressed by “1001”, this field indicates that BSSIDs indicated in BSSID #1 field and BSSID #4 field shall respond with link metrics based on collaborative transmission.

If the number of multi-AP devices involved in CT is already determined beforehand, CT BSSID field does not need to indicate it, e.g. by a bitmap. For example, if Num of BSS ID field indicates 6 and CT BSS ID #k indicates two multi-AP devices, each of them is indicated in BSSID #2 field and the other is indicated in BSSID #4 field, and each CT BSSID #i field can be expressed by 4 bits because the number of all possible combinations is 15. It is also determined among the transmitters and the receivers which number corresponds to which combination of multi-AP devices indicated in the BSSID subfields.

In an embodiment the CT Link Metric Query frame can specify the resource units (RUs), of which estimated data rates are fed back from the relay nodes to the source node in the CT Link Metric Response. For instance, the relay nodes may respond to the query with a CT Link Metric Response, in which measured or estimated data rates of some RUs are included.

Referring again to FIG. 5, after receiving the link metric query in step 306, each relay node may carry out NDP-A/NDP in step 308 depending on the age of the channel state information that it has. The decision whether relay nodes carry out NDP-A/NDP for collaborative transmission is made by one of the relay nodes, which may be called “Sharing AP”. The Sharing AP would be the device that obtains a transmit opportunity (TXOP) fastest among the relay nodes after the link metric query is sent. If the Sharing AP decides to carry out an NDP-A/NDP trigger for NDP-A and NDP, the trigger for NDP-A/NDP is sent in step 307 to other relay nodes, which may be called “Shared APs”, prior to sending NDPA/NDP in step 308.

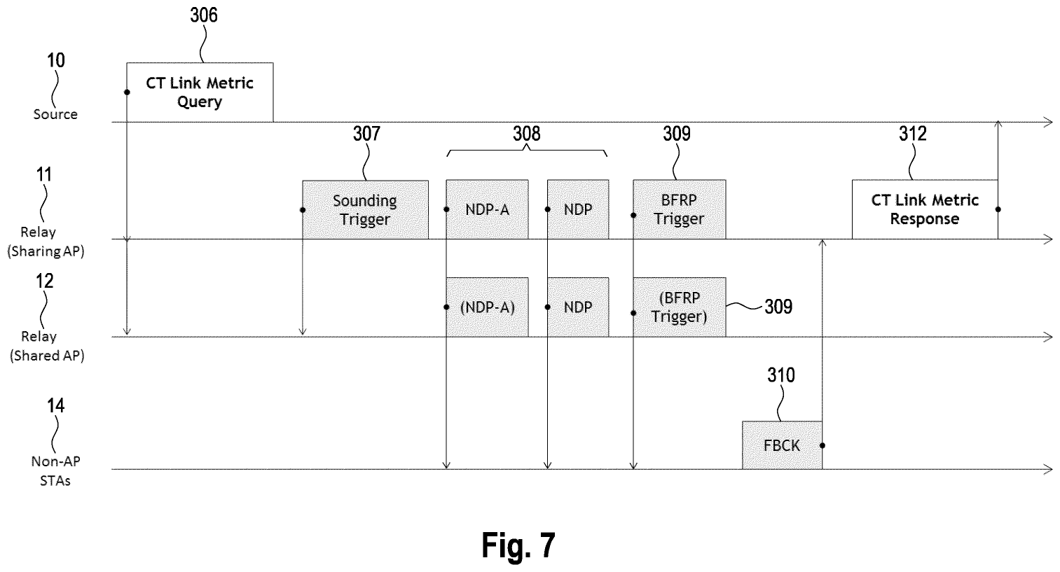

FIG. 7 shows a diagram illustrating another embodiment of a communication scheme of the communication between the different communication devices according to the present disclosure. FIG. 7 particularly illustrates an embodiment of the steps from the CT Link Metric Query to the CT Link Metric Response under the assumption that the CT Link Metric Query includes CT BSSID #k field indicating relay nodes 11 and 12. In FIG. 7, the relay node 11 is also assumed to obtain TXOP faster than any other relay node and to send a Sounding Trigger to relay node 12. Thus, the relay node 11 can be called the Sharing AP and the relay node 12 can be called the Shared AP. The TXOP may be obtained by an exchange RTS frame and CTS frame, as e.g. standardized in IEEE 802.11, among the relay nodes 11 and 12, after transmission of the JT Link Metric Query. It shall be noted that the source node does not need to be a TXOP holder after sending the JT Link Metric Query.

After receiving the Sounding Trigger in step 307, the relay nodes 11 and 12 send NDP-A (subsequently or—preferably—at the same time) and NDP (subsequently or—preferably—at the same time) to the non-AP STA(s) 14 (step 308). Known sequences may be included in NDP to estimate the channel state at the non-AP STA(s), which may be orthogonal to each other so that each non-AP STA can estimate each channel from each antenna of the relay nodes to each non-AP STA's antenna.

A BFRP (Beamforming Feedback Report) Trigger may optionally follow (step 309) the transmission of NDP to solicit the non-AP STA(s) to feedback channel estimation (Sounding FBCK) to at least the sharing AP (relay node 11 in this embodiment) in step 310. The BFRP trigger may be sent by the relay node 11 (Sharing AP), but it may also be sent by the relay node 12 (Shared AP) at the same time. The content of the BFRP Trigger may be identical to the BFRP Trigger standardized in IEEE 802.11. The relay node 12 may also be included as one of the intended receiving non-AP STA(s) of the Sounding FBCK transmitted in step 310.

After receiving the Sounding FBCK from the non-AP STA(s), the relay node 11 estimates (step 311) the data rate for at least one of the collaborative transmission types and the non-collaborative transmission such as SU (Single User) MIMO or MU (Multi User) MIMO. The data rates may be estimated based on 1) each RU (Resource Unit) that the relay node 11 can arbitrarily decide or is indicated in the JT Link Metric Query frame, and 2) each combination of non-AP STA(s). The relay node 11 may refer to a PER (Packet Error Rate) table when estimating the data rates. For example, if PER=0.1 is set to the criteria for each transmission, the relay node 11 may calculate the channel gain based on CSI (Channel State Information) regarding channels between relay nodes and STAs. The algorithm to determine the channel gain varies widely, but one of the well-known ways is combination of SVD (Singular Vectors Decomposition) and a water-filling algorithm under the restriction of MCS (Modulation and Coding Scheme) capabilities of each communication device. The packet size can be assumed to be 1500 bits when considering PER.

As illustrated above, the CT Link Metric Query can specify RUs, of which an estimated data rate shall be included in the CT Link Metric Response. If the CT Link Metric Query specifies RUs, the data rate for each RU shall be indicated in the CT Link Metric Response. The reason is that when a source node sends data to relay nodes, the data size for each non-AP STA is usually different, and thus, for example, some data are going to be sent in CJT on RU #1 by relay nodes, but the other data would be sent in another BF type or non-CT on a different RU. To provide flexibility for the transmission route as well as to provide an efficient transmission at the relay nodes, the estimated data rate is preferably indicated on RU basis.

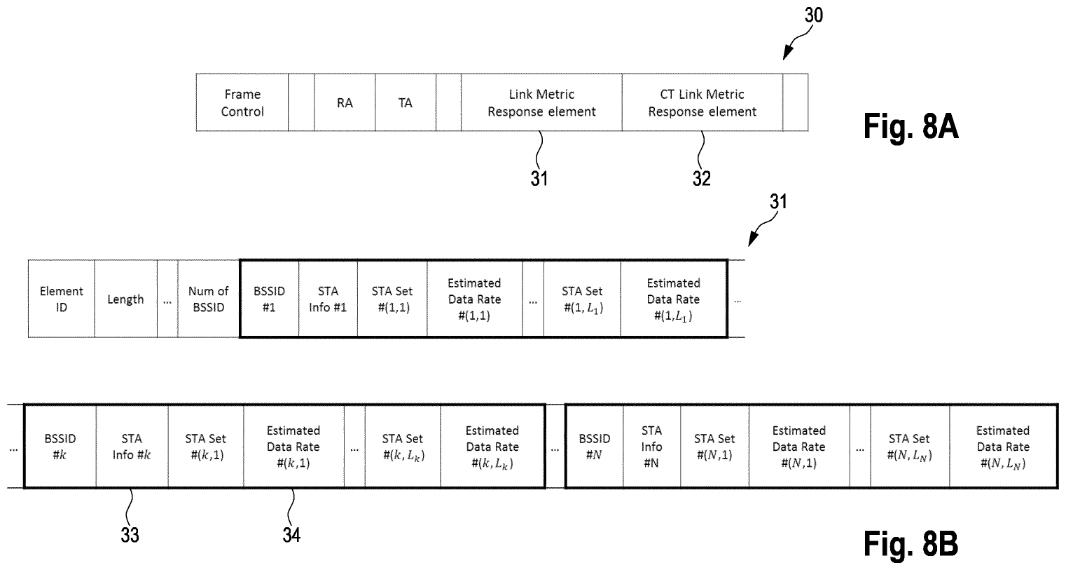

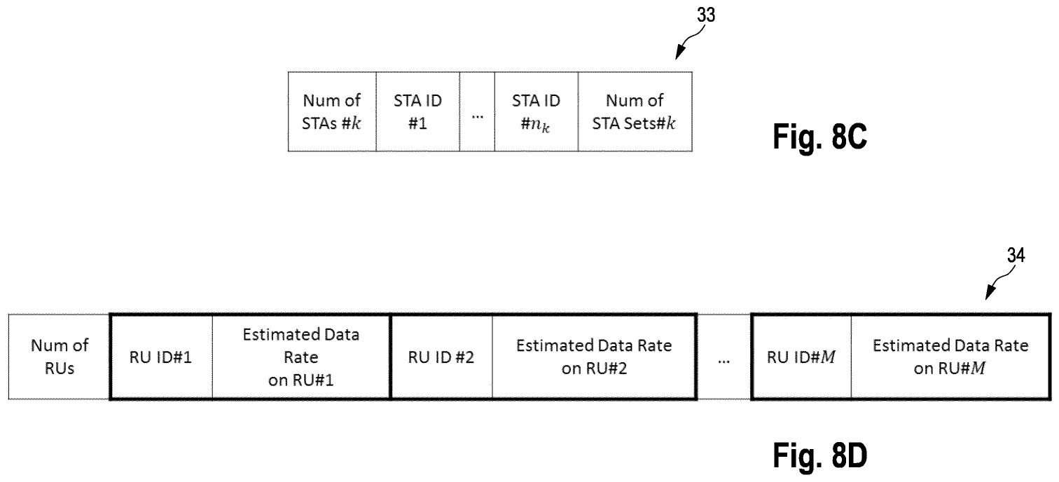

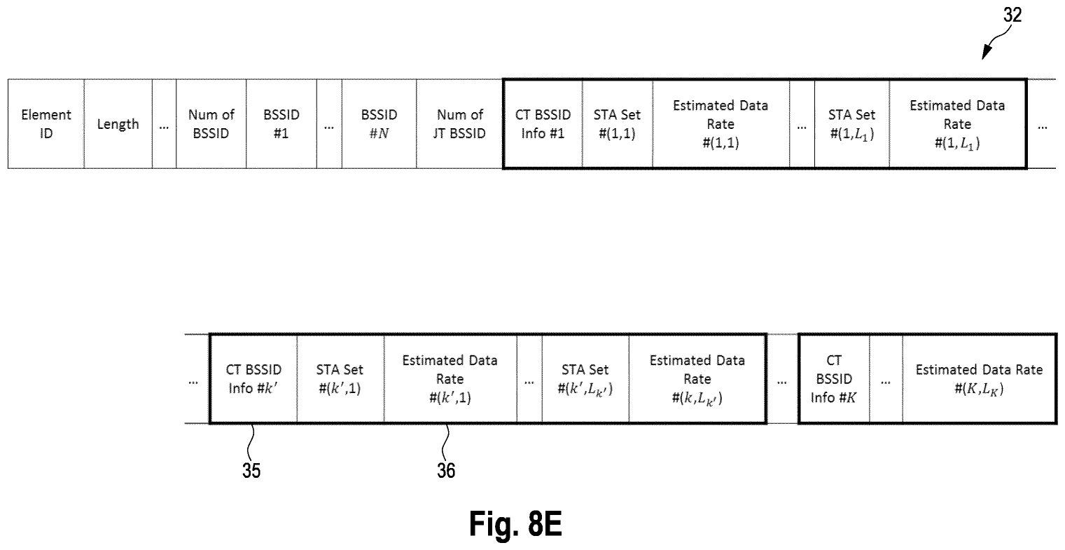

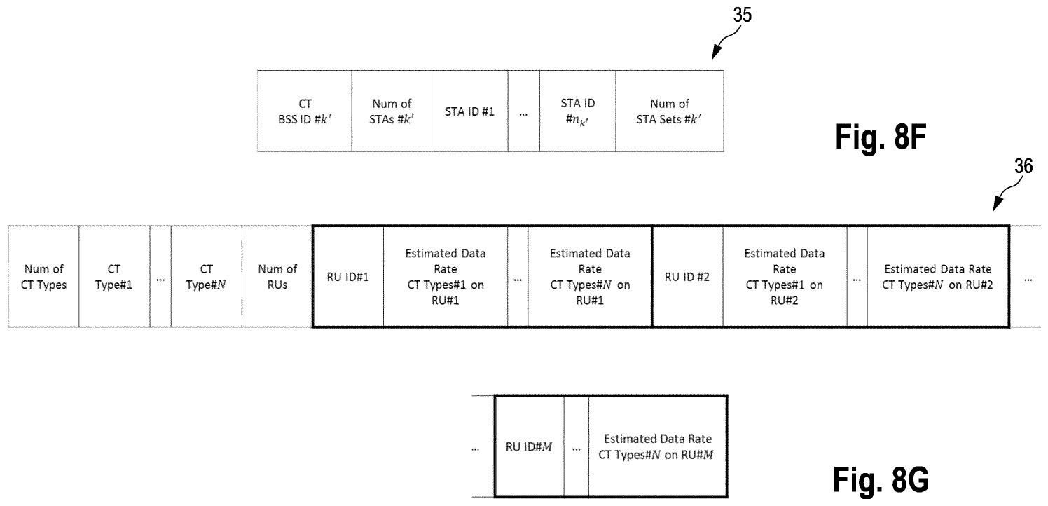

After estimating the data rate based on the sounding feedback, the relay node 11 sends the data rate information about the estimated data rates in step 312 to the source node 10 in a CT Link Metric Response. FIG. 8 shows an example of a CT Link Metric Response frame 30 and embodiments of the different fields.

FIG. 8A shows an exemplary general layout of the CT Link Metric Response frame 30 according to the present disclosure. This frame may include one or more of the following fields (in an embodiment, all these fields are included; in other embodiments only single fields or groups of fields are included; additional fields may be included as well):
Frame Control: indicates types of this frame; basically, this field is interpreted with Element ID in CT Link Metric Response element or Link Metric Response element;
RA (Receiving STA Address): indicates to which non-AP STA(s) this frame is intended to be sent;
TA (Transmitting STA Address): indicates from which non-AP STA this frame is transmitted;
Link Metric Response element 31: includes link metrics among BSSIDs, which are requested to be informed in CT Link Metric Query;
CT Link Metric Response element 32: includes link metrics for CT by multi-AP devices; the combination of multi-AP devices is specified in CT BSSID fields in the CT Link Metric Query.

The difference point between Link Metric Response element and CT Link Metric Response element is that the Link Metric Response element includes link metrics for non-CT, but the CT Link Metric Response element includes link metrics for CT. Link Metric Response element does not need to be included in the CT Link Metric Response.

The Link Metric Response element 31 is illustrated in FIG. 8B and may include one or more of the following fields:
Element ID: indicates which element this element is;
Length: indicates what bits or octets are used in the Link Metric Response element;
Num of BSSID: indicates the number of BSSID fields in the element, which information is included in the Link Metric Query element. For example, this field indicates the value of N;
BSSID #k: indicates the transmitter of estimated data rates, which are indicated in Estimated Data Rate #(k, i) fields, where i is an arbitrary integer value; the BSS of the transmitter's Fronthaul AP shall be in the BSS indicated in the field;
STA Info #k 33: indicates which non-AP STA(s) can be potentially included in STA Set #(k, i) field;
STA Set #(k, i): indicates the receivers of estimated data rates indicated in Estimated Data Rate #(k, i) field; if Num of STA Sets #k subfield indicates the value of R, this field can be expressed by R bits, where the I-th bit indicates whether the non-AP STA indicated in STA ID #I field in STA Info #k field is counted as the receiver of the estimated data rate indicated in Estimated Data Rate #(k, i) field (for example, if Num of STA Sets #k subfield indicates 4 and STA Set #(k, i) field includes “1001”, the non-AP STAs indicated in STA ID #1 subfield and STA ID #4 subfield in STA Info #k field are counted as the receivers of the estimated data rate which is indicated in Estimated Data Rate #(k, i) field);
Estimated Data Rate #(k, i) 34: indicates the estimated data rate among the transmitter and the receivers; the transmitter is a device with Fronthaul AP in the BSS where BSSID #k field indicates BSSID, and the receivers are devices indicated in STA Set #(k, i) field (although there are several variants of non-collaborative transmission, datarate indicated in this field can be determined based on the one of non-collaborative transmission which yields better data rate than any other).

The STA Info #k field 33 may include one or more of the following subfields as illustrated in FIG. 8C:
Num of STAs #k: indicates the number of the following consecutive STA ID subfields;
STA ID #j: indicates the j-th STA potentially included in STA Set #(k, i), where j is an arbitrary integer value;
Num of STA Sets #k: indicates the number of Estimated Data Rate #(k, i) fields'; in FIG. 8C, Num of STA Sets #k subfield indicates the value of Lₖ, which can be determined by the transmitter of Link Metric Response element.

The Estimated Data Rate #(k, i) field 34 may include one or more of the following subfields as illustrated in FIG. 8D:
Num of RUs: indicates the number of RU ID subfields in the Estimated Data Rate #(k, i) field;
RU ID #l: indicates the I-th RU of which the estimated data rate is indicated in Estimated data rate on RU #l subfield;

Estimated Data Rate on RU #l: indicates the estimated data rate on RU indicated in RU #l subfield; the intended transmitter is the device with Fronthaul AP whose BSS is indicated in BSSID #k field, and the intended receivers are the devices indicated in STA Info #k field.

The above parameters i, j, k and l are arbitrary integer values.

The CT Link Metric Response element 32 is illustrated in FIG. 8E and may include one or more of the following fields:
Element ID: indicates which element this element is;
Length: indicates what bits or octets are used in the CT Link Metric Query element;
Num of BSSID: indicates the number of consecutive following BSSID #i elements;
BSSID #i: indicates the i-th BSSID of which link metrics for collaborative transmission are included in the element;
Num of CT BSSID: indicates the number of BSSID combinations, of which link metrics for collaborative transmission are included in the element;
CT BSSID Info #k′ 35: indicates the information regarding k′-th combination of BSSIDs, of which the estimated data rates for collaborative transmission are included in Estimated Data Rate #(k′, i) field, where i is an arbitrary integer value;
STA Set #(k′, j): indicates the intended receivers of estimated data rate indicated in Estimated Data Rate #(k′, j) field;
Estimated Data Rate #(k′, j) 36: indicates the estimated data rate among the transmitters and the receivers, which are indicated in CT BSS ID #k′ subfield and STA Set #(k′, j) field, respectively.

It shall be noted that the CT Link Metric Response frame may further include information indicating the buffer status of the transmitter.

The CT BSSID Info #k′ field 35 may include one or more of the following subfields as illustrated in FIG. 8F:
CT BSSID #k′: indicates the k′-th combination of BSSIDs, in which multi-AP devices are intended transmitters of estimated data rate indicated in Estimated Data Rate #(k′, j) field, where j is an arbitrary integer value.
Num of STAs #k′: indicates the number of the following consecutive STA ID subfields
STA ID #i: indicates the k-th STA, of which estimated data rates are included in the Estimated Data Rate #(k′, i) field
Num of STA Set #k′: indicates the number of the STA Set #(k′, j) fields. As shown in the figure, for example, if the number of STA Set #(k′, j) fields is Lᵢ, this value is included in the Num of STA Set #k′ subfield, where j is an arbitrary integer value.

The Estimated Data Rate #(k′, j) field 36 may include one or more of the following subfields as illustrated in FIG. 8G:
Num of CT Types: indicates the number of CT Type subfields in the Estimated Data Rate #(k′, j) field;
CT Type #l: indicates the intended CT Type of the estimated data rate indicated in Estimated Data Rate CT Type #l on RU #m subfield, where l and m are arbitrary integer values; This field may have three variants, which indicates CJT, NCJT and CBF;
Num of RUs: indicates the number of RU ID subfields included in the Estimated Data Rate #(k′, j) field;
RU ID #m: indicates the m-th RU of which the estimated data rate is indicated in Estimated data rate CT Type #l on RU #m subfield;
Estimated Data Rate CT Types #l on RU #m: indicates estimated data rate, where CT type is one indicated in CT Type #l subfield and RU is one indicated in RU ID #m subfield.

It shall be noted that the relay node decides which link metric of which BF type are fed back. This is because NDP sounding is assumed to be done by multiple relay nodes at the same time so that the sink node can know global CSI (e.g. 4-by-2 channel matrix if each device has two antennas, not 2×2-by-2 channel matrices)

Referring again to FIG. 5, after receiving the CT Link Metric Response from relay nodes in step 312, the source node decides which BF types to be used for relaying data via the relay nodes. As mentioned above, the best BF Type at relay nodes depends on the data traffic and/or buffer status of relay nodes. The source node may choose the BF Type on RU basis.

In a non-limiting embodiment, the decision of the source node may be performed as follows. Data traffic at the source node can be considered in BF Type Decision. For the subsequent example, it shall be assumed that there are two sink nodes, to which data will be sent via relay nodes from the source node (as e.g. illustrated in FIG. 1), and that the source node has D₂[bits] for non-AP STA 14, and D₃[bits] for non-AP STA 15. Further, it shall be assumed that the indicated value for non-AP STAi from relay nodej in “Estimated Data Rate CT Types #k on RU #l is C_{(i,j,k,l)}[bps/Hz], and the indicated value for non-AP STAi from relay nodej in “Estimated Data Rate on RU #” is C_{(i,j,0,l)}[bps/Hz].

At first, the source node can estimate the best BF Type on RU basis for communication among relay nodes and the sink node. The below equation (2) is one example to determine BF Types, where RU is chosen for every BF Type, but fundamentally it can also be seen to choose BF Types in each RU.

$${max}_{{j}_{0} , … {j}_{N} , {RU}^{( 2 , 0 )} , R {U}^{( 3 , 0 )} … , {RU}^{( 2 , N )} , {RU}^{( 3 , N )}} {\sum }_{k = 0}^{N} {\sum }_{l ∈ R {U}^{( k )}} {C}_{( 2 , {j}_{k} , k , l )} s . t . \frac{( 1 - ε ) {D}_{2}}{{D}_{3}} \leq \frac{{\sum }_{\begin{matrix}k = 0 \\ k \neq p\end{matrix}}^{N} {\sum }_{l ∈ {RU}^{( 2 , k )}} {C}_{( 2 , j , k , l )} + {\sum }_{l ∈ ( {RU}^{( 2 , p )} )} {C}_{( 2 , j , p , l )}}{{\sum }_{\begin{matrix}k = 0 \\ k \neq p\end{matrix}}^{N} {\sum }_{l ∈ {RU}^{( 3 , k )}} {C}_{( 3 , j , k , l )} + {\sum }_{l ∈ ( {RU}^{( 3 , p )} )} {C}_{( 3 , j , p , l )}} \leq \frac{( 1 - ε ) {D}_{2}}{{D}_{3}} \qquad ( 2 )$$

In equation (2) N is the maximum number of potential BF Types, RU^{(i,k)} is RU set where BF Type k is chosen as the best BF for non-AP STAi, and ε is arbitrary real number. jₖ takes value of one or two unless k is p, which indicates BF Type of CJT. The reason of ε is that the following equation (3) may not hold in most cases, and padding may be needed for PPDU to some extent. The value of ε can e.g. be set to 0.1.

$${max}_{{j}_{0} , … {j}_{N} , {RU}^{( 2 , 0 )} , R {U}^{( 3 , 0 )} … , {RU}^{( 2 , N )} , {RU}^{( 3 , N )}} {\sum }_{k = 0}^{N} {\sum }_{l ∈ R {U}^{( k )}} {C}_{( 2 , {j}_{k} , k , l )} s . t . \frac{{D}_{2}}{{D}_{3}} = \frac{{\sum }_{\begin{matrix}k = 0 \\ k \neq p\end{matrix}}^{N} {\sum }_{l ∈ {RU}^{( 2 , k )}} {C}_{( 2 , {j}_{k} , k , l )} + {\sum }_{l ∈ ( {RU}^{( 2 , p )} )} {C}_{( 2 , j , p , l )}}{{\sum }_{\begin{matrix}k = 0 \\ k \neq p\end{matrix}}^{N} {\sum }_{l ∈ {RU}^{( 3 , k )}} {C}_{( 3 , {j}_{k} , k , l )} + {\sum }_{l ∈ ( {RU}^{( 3 , p )} )} {C}_{( 3 , j , p , l )}} \qquad ( 3 )$$

Next, the source node may choose the best BF Type on RU basis for communication from the source node to the relay nodes so that transmission duration is shortest among all possibilities. The following equation (4) is one example to determine BF Types, where C′_{(i,k,l)}[bps/Hz] is the estimated data rate of communication between the source node and the relay node #i with BF Type #k′ on RU #l.

$${max}_{{RU}^{( 0 )} , … , {RU}^{( {N}^{′} )}} {\sum }_{{k}^{′} = 0}^{{N}^{′}} {\sum }_{{l}^{′} ∈ {RU}^{( {k}^{′} )}} {{C}^{′}}_{( 2 , {k}^{′} , {l}^{′} )} s . t . \frac{( 1 - {ε}^{′} ) \tilde{{D}_{1}}}{\tilde{{D}_{2}}} \leq \frac{{\sum }_{{k}^{′} = 0}^{{N}^{′}} {\sum }_{{l}^{′} ∈ {RU}^{( 1 , {k}^{′} )}} {C}_{( 1 , {k}^{′} , {l}^{′} )} + {\sum }_{{l}^{′} ∈ ( {RU}^{( 1 , {p}^{′} )} )} {C}_{( 1 , {p}^{′} , {l}^{′} )}}{{\sum }_{{k}^{′} = 0}^{{N}^{′}} {\sum }_{{l}^{′} ∈ {RU}^{( 2 , {k}^{′} )}} {C}_{( 2 , {k}^{′} , {l}^{′} )} + {\sum }_{{l}^{′} ∈ ( {RU}^{( 2 , {p}^{′} )} )} {C}_{( 2 , {p}^{′} , {l}^{′} )}} \leq \frac{( 1 - {ε}^{′} ) \tilde{{D}_{1}}}{\tilde{{D}_{2}}} \qquad ( 4 )$$

In equation (4) \tilde{D}ₗ is data traffic to relay node i, which is calculated from j₀, . . . j_{N}, RU^{(2,0)}, RU^{(3,0)} . . . , RU^{(2,N)}, RU^{(3,N)} in equation (2), N′ is the maximum number of potential BF Types of source node, RU^{(i′,k′)} is RU set where BF Type k′ is chosen as the best BF for relay node i′, and a′ is an arbitrary real number. The value of p′ indicates BF Type of Multicast BF. The reason of E′ is that the following equation (5) may not hold in most cases, and padding may be needed for PPDU to some extent. The value of ε′ can e.g. be set 0.1.

$${max}_{{RU}^{( 0 )} , … , {RU}^{( {N}^{′} )}} {\sum }_{{k}^{′} = 0}^{{N}^{′}} {\sum }_{{l}^{′} ∈ {RU}^{( {k}^{′} )}} {{C}^{′}}_{( 2 , {k}^{′} , {l}^{′} )} s . t . \frac{\tilde{{D}_{1}}}{\tilde{{D}_{2}}} \leq \frac{{\sum }_{{k}^{′} = 0}^{{N}^{′}} {\sum }_{{l}^{′} ∈ {RU}^{( 1 , {k}^{′} )}} {C}_{( 1 , {k}^{′} , {l}^{′} )} + {\sum }_{{l}^{′} ∈ ( {RU}^{( 1 , {p}^{′} )} )} {C}_{( 1 , {p}^{′} , {l}^{′} )}}{{\sum }_{{k}^{′} = 0}^{{N}^{′}} {\sum }_{{l}^{′} ∈ {RU}^{( 2 , {k}^{′} )}} {C}_{( 2 , {k}^{′} , {l}^{′} )} + {\sum }_{{l}^{′} ∈ ( {RU}^{( 2 , {p}^{′} )} )} {C}_{( 2 , {p}^{′} , {l}^{′} )}} \qquad ( 5 )$$

After making decision of the BF Type, the source node sends data in step 313, where final destinations are non-AP STA(s), to the relay nodes. The applied BF types can be different on RU basis. Especially if the source node sends the same data, which are intended to be sent in CJT from relay nodes to non-AP STA(s), to relay nodes, the source node can send the data in Multicast BF. The source node can notify the relay nodes which data to be sent in which BF Type at the same time. This part is similar with CJT, where there are one Sharing AP and two Shared APs.

After receiving data to be sent non-AP STAs, the relay nodes send the data to non-AP STA(s) in step 314. BF Types can be different on RU basis.

In summary, according to the present disclosure a first communication device operating as source node sends a link metric query to relay nodes which solicits the relay nodes to feedback measured/estimated values of several joint transmission data rate. At least one second communication device operating as relay node thus sends a link metric response to the source node. The link metric response includes measured/estimated values of several joint transmission data rate among relay nodes and sink nodes (non-AP STAs). This data rate may be indicated on the basis of each RU.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriate circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:

1. First communication device configured to operate as source node and communicate with one or more second communication devices that are configured to operate as relay nodes and communicate with one or more third communication devices, the first communication device comprising circuitry configured to:
transmit a collaborative transmission (CT) link metric query to multiple second communication devices requesting them to collect CT link metric information with respect to collaborative transmission from two or more of said second communication devices to one or more third communication devices, the link metric query including one or more CT indications, each CT indication indicating a different combination of two or more second communication devices and/or different beamforming (BF) types for which CT link metric information shall be collected,
receive a CT link metric response from at least one of said multiple second communication devices in response to the transmitted CT link metric query, the link metric response including the collected CT link metric information,
decide, based on the CT link metric response, BF types to be used by the multiple second communication devices for collaborative transmission to one or more third communication devices, and
transmit CT type information indicating the decided BF types to the multiple second communication devices.

2. First communication device as defined in embodiment 1, wherein the circuitry is configured to decide BF types to be used by selection of one BF type from a group of BF types comprising Coherent Joint Transmission, Non-Coherent Joint Transmission, Joint Transmission, Coordinated Beamforming and Non-Joint Transmission.

3. First communication device as defined in any one of the preceding embodiments, wherein the circuitry is configured to include in the CT link metric query CT number information indicating the number of CT indications included in the CT link metric query.

4. First communication device as defined in any one of the preceding embodiments, wherein the circuitry is configured to include in the CT link metric query one or more first AP indications and/or one or more second AP indications, each first AP indication indicating a different set of one or more second communication devices for which CT link metric information with respect to transmission from the respective second communication device to a third communication device shall be collected and each second AP indication indicating a different second communication device for which CT link metric information with respect to transmission from said second communication device to a third communication device shall be collected.

5. First communication device as defined in embodiment 4, wherein the circuitry is configured to include in the CT link metric query AP number information indicating the number of first and/or second AP indications included in the CT link metric query.

6. First communication device as defined in any one of the preceding embodiments, wherein the circuitry is configured to include in the link metric query one or more of: receiving information indicating to which second communication devices the link metric query is addressed,
transmit information indicating the first communication device from which the link metric query is transmitted and/or to which first communication device the link metric response shall be transmitted,
comeback policy information indicating a time frame within which the CT link metric response shall be transmitted by the at least one of said multiple second communication devices, and
resource unit (RU) information indicating one or more RUs, for which collected CT link metric information shall be included in the CT link metric response.

7. First communication device as defined in any one of the preceding embodiments, wherein the circuitry is configured to decide the BF type for use by a second communication device based on data rate information included in the CT link metric response, the data rate information indicating estimated data rates for different BF types.

8. First communication device as defined in embodiment 7, wherein the circuitry is configured to decide the BF type for use by a second communication device by minimizing transmission time from the second communication device to respective third communication devices based on the data traffic to the third communication device.

9. First communication device as defined in any one of the preceding embodiments, wherein the CT link metric information includes data rate information on an estimated data rate regarding the channel between a second communication device and a third communication device.

10. Second communication device configured to operate as relay node and communicate with a first communication device configured to operate as source node, one or more other second communication devices configured to operate as relay nodes and/or one or more third communication devices configured to communicate with one or more second communication devices, the second communication device comprising circuitry configured to:
receive a collaborative transmission (CT) link metric query from the first communication device requesting it to collect CT link metric information with respect to collaborative transmission from the second communication device and one or more other second communication devices to one or more third communication devices, the CT link metric query including one or more CT indications, each CT indication indicating a different combination of two or more second communication devices and/or different beamforming (BF) types for which CT link metric information shall be collected,
transmit a CT link metric response to the first communication device in response to the transmitted CT link metric query, the CT link metric response including the collected CT link metric information,
receive, from the first communication device, BF type information indicated decided BF types to be used by the second communication device for collaborative transmission to a third communication device, and
transmit data to a third communication device jointly with one or more other second communication devices using the BF type indicated for the second communication device in the received BF type information.

11. Second communication device as defined in embodiment 10, wherein the circuitry is configured to transmit, in response to receipt of the CT link metric query, null data packets to one or more third communication devices and to receive, from said one or more third communication devices in response to the transmitted null data packets, data information on an estimated data rate regarding the channel between the second communication device and the respective third communication device.

12. Second communication device as defined in embodiment 10 or 11, wherein the circuitry is configured to obtain, in response to receipt of the CT link metric query, a transmit opportunity and to transmit a sounding trigger to one or more other second communication devices to transmit null data packets to one or more third communication devices simultaneously with the transmission of null data packets to said one or more third communication devices by the second communication device.

13. Second communication device as defined in embodiment 12, wherein the circuitry is configured to transmit a sounding trigger to the other second communication devices indicated in the CT link metric query.

14. Second communication device as defined in embodiment 11, wherein the circuitry is configured to transmit, after the transmission of the null data packets, a feedback trigger to the one or more third communication devices to feedback, at least to the second communication device, data rate information on an estimated data rate regarding the channel between a third communication device and the second communication device that transmitted the null data packets to the third communication device.

15. Second communication device as defined in embodiment 11, wherein the circuitry is configured to determine, based on the received data rate information estimated data rates for different types of CT transmission and non-CT transmission and to include estimated data rates in the CT link metric response.

16. Second communication device as defined in any one of the embodiments 10 to 15, wherein the circuitry is configured to include in the CT link metric response one or more of:
receiving information indicating to which first communication device the CT link metric response is addressed,
transmit information indicating from which second communication device the CT link metric response is transmitted,
link metric response information indicating link metric information with respect to non-CT transmission from different second communication devices to respective third communication devices, and
CT link metric response information indicating CT link metric information with respect to CT transmission from different second communication devices to respective third communication devices.

17. Second communication device as defined in embodiment 16, wherein the circuitry is configured to include, in the link metric response information and/or the CT link metric response information, the link metric information and/or the CT link metric information per resource unit (RU).

18. First communication method of a first communication device that is configured to operate as source node and communicate with one or more second communication devices that are configured to operate as relay nodes and communicate with one or more third communication devices, the first communication method comprising:
transmitting a collaborative transmission (CT) link metric query to multiple second communication devices requesting them to collect CT link metric information with respect to collaborative transmission from two or more of said second communication devices to one or more third communication devices, the link metric query including one or more CT indications, each CT indication indicating a different combination of two or more second communication devices and/or different beamforming (BF) types for which CT link metric information shall be collected,
receiving a CT link metric response from at least one of said multiple second communication devices in response to the transmitted CT link metric query, the link metric response including the collected CT link metric information,
deciding, based on the CT link metric response, BF types to be used by the multiple second communication devices for collaborative transmission to one or more third communication devices, and
transmitting BF type information indicating the decided BF types to the multiple second communication devices.

19. Second communication method of a second communication device configured to operate as relay node and communicate with a first communication device configured to operate as source node, one or more other second communication devices configured to operate as relay nodes and/or one or more third communication devices configured to communicate with one or more second communication devices, the second communication method comprising:
receiving a collaborative transmission (CT) link metric query from the first communication device requesting it to collect CT link metric information with respect to collaborative transmission from the second communication device and one or more other second communication devices to one or more third communication devices, the CT link metric query including one or more CT indications, each CT indication indicating a different combination of two or more second communication devices and/or different beamforming (BF) types for which CT link metric information shall be collected,
transmitting a CT link metric response to the first communication device in response to the transmitted CT link metric query, the CT link metric response including the collected CT link metric information,
receiving, from the first communication device, BF type information indicated decided BF types to be used by the second communication device for collaborative transmission to a third communication device, and
transmitting data to a third communication device jointly with one or more other second communication devices using the BF type indicated for the second communication device in the received BF type information.

20. A non-transitory computer-readable recording medium that stores therein a computer program product, which, when executed by a processor, causes the method according to embodiment 18 or 19 to be performed.

21. A computer program comprising program code means for causing a computer to perform the steps of said method according to embodiment 18 or 19 when said computer program is carried out on a computer.

22. First communication device as defined in any one of embodiments 1 to 9, wherein the circuitry is configured to perform capability exchange with the one or more second multi-AP and/or one or more other communication devices.

23. First communication device as defined in any one of embodiments 1 to 9 and 22, wherein the circuitry is configured to transmit null data packets to one or more second multi-AP devices and to receive, from said one or more second multi-AP devices in response to the transmitted null data packets, channel state information regarding the channel between the first multi-AP device and the respective second multi-AP device.

24. First communication device as defined in any one of embodiments 1 to 9, 22 and 23,
wherein the circuitry comprises a multi-access point entity and a fronthaul access point.

25. Second communication device as defined in any one of embodiments 10 to 17, wherein the circuitry is configured to perform capability exchange with the first multi-AP device and one or more other communication devices configured to operate as sink nodes.

26. Second communication device as defined in any one of embodiments 10 to 17 and 25,
wherein the circuitry is configured to receive null data packets from the first multi-AP device and to transmit to the first multi-AP device in response to the received null data packets, channel state information regarding the channel between the second multi-AP device and the first multi-AP device.

27. Second communication device as defined in any one of embodiments 10 to 17, 25 and 26,
wherein the circuitry comprises a multi-AP entity, a backhaul station and a fronthaul access point.

1. First communication device configured to operate as source node and communicate with one or more second communication devices that are configured to operate as relay nodes and communicate with one or more third communication devices, the first communication device comprising circuitry configured to:
transmit a collaborative transmission (CT) link metric query to multiple second communication devices requesting them to collect CT link metric information with respect to collaborative transmission from two or more of said second communication devices to one or more third communication devices, the link metric query including one or more CT indications, each CT indication indicating a different combination of two or more second communication devices and/or different beamforming (BF) types for which CT link metric information shall be collected,
receive a CT link metric response from at least one of said multiple second communication devices in response to the transmitted CT link metric query, the link metric response including the collected CT link metric information,
decide, based on the CT link metric response, BF types to be used by the multiple second communication devices for collaborative transmission to one or more third communication devices, and
transmit CT type information indicating the decided BF types to the multiple second communication devices.

2. First communication device as claimed in claim 1,
wherein the circuitry is configured to decide BF types to be used by selection of one BF type from a group of BF types comprising Coherent Joint Transmission, Non-Coherent Joint Transmission, Joint Transmission, Coordinated Beamforming and Non-Joint Transmission.

3. First communication device as claimed in claim 1,
wherein the circuitry is configured to include in the CT link metric query CT number information indicating the number of CT indications included in the CT link metric query.

4. First communication device as claimed in claim 1,
wherein the circuitry is configured to include in the CT link metric query one or more first AP indications and/or one or more second AP indications, each first AP indication indicating a different set of one or more second communication devices for which CT link metric information with respect to transmission from the respective second communication devices to one or more third communication devices shall be collected and each second AP indication indicating a different second communication device for which CT link metric information with respect to transmission from said second communication device to a third communication device shall be collected.

5. First communication device as claimed in claim 4,
wherein the circuitry is configured to include in the CT link metric query AP number information indicating the number of first and/or second AP indications included in the CT link metric query.

6. First communication device as claimed in claim 1,
wherein the circuitry is configured to include in the CT link metric query one or more of:
receiving information indicating to which second communication devices the CT link metric query is addressed,
transmit information indicating the first communication device from which the CT link metric query is transmitted and/or to which first communication device the CT link metric response shall be transmitted,
comeback policy information indicating a time frame within which the CT link metric response shall be transmitted by the at least one of said multiple second communication devices, and
resource unit (RU) information indicating one or more RUs, for which collected CT link metric information shall be included in the CT link metric response.

7. First communication device as claimed in claim 1,
wherein the circuitry is configured to decide the BF type for use by a second communication device based on data rate information included in the CT link metric response, the data rate information indicating estimated data rates for different BF types.

8. First communication device as claimed in claim 7,
wherein the circuitry is configured to decide the BF type for use by a second communication device by minimizing transmission time from the second communication device to respective third communication devices based on the data traffic to the third communication device.

9. First communication device as claimed in claim 1,
wherein the CT link metric information includes channel state information regarding the channel between one or more second communication device and a third communication device.

10. Second communication device configured to operate as relay node and communicate with a first communication device configured to operate as source node, one or more other second communication devices configured to operate as relay nodes and/or one or more third communication devices configured to communicate with one or more second communication devices, the second communication device comprising circuitry configured to:
receive a collaborative transmission (CT) link metric query from the first communication device requesting it to collect CT link metric information with respect to collaborative transmission from the second communication device and one or more other second communication devices to one or more third communication devices, the CT link metric query including one or more CT indications, each CT indication indicating a different combination of two or more second communication devices and/or different beamforming (BF) types for which CT link metric information shall be collected,
transmit a CT link metric response to the first communication device in response to the transmitted CT link metric query, the CT link metric response including the collected CT link metric information,
receive, from the first communication device, BF type information indicated decided BF types to be used by the second communication device for collaborative transmission to a third communication device, and
transmit data to a third communication device jointly with one or more other second communication devices using the BF type indicated for the second communication device in the received BF type information.

11. Second communication device as claimed in claim 10,
wherein the circuitry is configured to transmit, in response to receipt of the CT link metric query, null data packets to one or more third communication devices and to receive, from said one or more third communication devices in response to the transmitted null data packets, channel state information regarding the channel between the second communication device and the respective third communication device.

12. Second communication device as claimed in claim 10,
wherein the circuitry is configured to obtain, in response to receipt of the CT link metric query, a transmit opportunity and to transmit a sounding trigger to one or more other second communication devices to transmit null data packets to one or more third communication devices simultaneously with the transmission of null data packets to said one or more third communication devices by the second communication device.

13. Second communication device as claimed in claim 12,
wherein the circuitry is configured to transmit a sounding trigger to the other second communication devices indicated in the CT link metric query.

14. Second communication device as claimed in claim 11,
wherein the circuitry is configured to transmit, after the transmission of the null data packets, a feedback trigger to the one or more third communication devices to feedback, at least to the second communication device, channel state information regarding the channel between a third communication device and the second communication device that transmitted the null data packets to the third communication device.

15. Second communication device as claimed in claim 11,
wherein the circuitry is configured to determine, based on the received channel state information indicating estimated data rates for different types of CT transmission and non-CT transmission and to include estimated data rates in the CT link metric response.

16. Second communication device as claimed in claim 10,
wherein the circuitry is configured to include in the CT link metric response one or more of:
receiving information indicating to which first communication device the CT link metric response is addressed,
transmit information indicating from which second communication device the CT link metric response is transmitted,
link metric response information indicating link metric information with respect to non-CT transmission from different second communication devices to respective third communication devices, and
CT link metric response information indicating CT link metric information with respect to CT transmission from different second communication devices to respective third communication devices.

17. Second communication device as claimed in claim 16,
wherein the circuitry is configured to include, in the link metric response information and/or the CT link metric response information, the link metric information and/or the CT link metric information per resource unit (RU).

18. First communication method of a first communication device that is configured to operate as source node and communicate with one or more second communication devices that are configured to operate as relay nodes and communicate with one or more third communication devices, the first communication method comprising:
transmitting a collaborative transmission (CT) link metric query to multiple second communication devices requesting them to collect CT link metric information with respect to collaborative transmission from two or more of said second communication devices to one or more third communication devices, the CT link metric query including one or more CT indications, each CT indication indicating a different combination of two or more second communication devices and/or different beamforming (BF) types for which CT link metric information shall be collected,
receiving a CT link metric response from at least one of said multiple second communication devices in response to the transmitted CT link metric query, the CT link metric response including the collected CT link metric information,
deciding, based on the CT link metric response, BF types to be used by the multiple second communication devices for collaborative transmission to one or more third communication devices, and
transmitting CT type information indicating the decided BF types to the multiple second communication devices.

19. Second communication method of a second communication device configured to operate as relay node and communicate with a first communication device configured to operate as source node, one or more other second communication devices configured to operate as relay nodes and/or one or more third communication devices configured to communicate with one or more second communication devices, the second communication method comprising:
receiving a collaborative transmission (CT) link metric query from the first communication device requesting it to collect CT link metric information with respect to collaborative transmission from the second communication device and one or more other second communication devices to one or more third communication devices, the CT link metric query including one or more CT indications, each CT indication indicating a different combination of two or more second communication devices and/or different beamforming (BF) types for which CT link metric information shall be collected,
transmitting a CT link metric response to the first communication device in response to the transmitted CT link metric query, the CT link metric response including the collected CT link metric information,
receiving, from the first communication device, BF type information indicated decided BF types to be used by the second communication device for collaborative transmission to a third communication device, and
transmitting data to a third communication device jointly with one or more other second communication devices using the BF type indicated for the second communication device in the received BF type information.

20. A non-transitory computer-readable recording medium that stores therein a computer program product, which, when executed by a processor, causes the method according to claim 18 or 19 to be performed.
